(19) United States
(12) Patent Application Publication
(10) Pub. No.: US 2025/0189914 A1
(43) Pub. Date: Jun. 12, 2025

(54) IMAGE FORMING APPARATUS

(71) Applicant: KYOCERA Document Solutions Inc., Osaka (JP)

(72) Inventor: Yuri Teshigawara, Osaka (JP)

(21) Appl. No.: 18/967,556

(22) Filed: Dec. 3, 2024

(30) Foreign Application Priority Data
Dec. 7, 2023 (JP) 2023-206665

(51) Int. Cl. G03G 15/20; G03G 15/00

(52) U.S. Cl. CPC G03G 15/205; G03G 15/2064; G03G 15/5004

(57) ABSTRACT

A fuser fixes a toner image on a print sheet using a fuser heater. A controller performs power control of the fuser heater for a heater control temperature. Further, the controller derives a correction value of the heater control temperature on the basis of an increment amount of sheet interval time in continuous printing and a heater turning-on time, derives the heater control temperature by correcting a predetermined reference value by the correction value within a range that the correction value does not exceed an upper limit value, sets the upper limit value on the basis of the increment amount and the heater turning-on time, and decreases a value of the heater turning-on time when the sheet interval time of the print sheet decreases. Here, the heater turning-on time is a value that indicates an accumulated time of power-on time of the fuser heater from starting the continuous printing.

### CROSS-REFERENCE TO RELATED APPLICATIONS

This application relates to and claims priority rights from Japanese Patent Application No. 2023-206665, filed on Dec. 7, 2023, the entire disclosures of which are hereby incorporated by reference herein.

### BACKGROUND

### 1. Field of the Present Disclosure

The present disclosure relates to an image forming apparatus.

### 2. Description of the Related Art

An image forming apparatus performs heater control of a fuser, and when performing the heater control, the image forming apparatus changes a heater turning-on duty at a time point that a recording medium (a print sheet) comes into a heater such that a sum of passing time of the recording medium and sheet interval time is set to be an integer multiple of a control period of the heater.

Usually in order to keep fixation temperature (temperature of a fuser belt or the like) constant, a heater control temperature is decreased with time. At that time, the heater control temperature is derived by subtracting a correction value from a reference value of the heater control temperature, and the correction value is changed with time.

Further, in a sheet interval, the fuser does not nip a print sheet, and therefore, fuser belt temperature tends to increase. A time length of sheet interval time may change due to change of a print sheet size, change of a sheet feeding cassette or the like in continuous printing. If the sheet interval time decreases, fixation temperature may decrease.

### SUMMARY

An image forming apparatus according to an aspect of the present disclosure includes a fuser and a controller. The fuser is configured to fix a toner image on a print sheet using a fuser heater in a heating- and pressurizing manner. The controller is configured to perform power control of the fuser heater for a heater control temperature. Further, the controller (a) derives a correction value of the heater control temperature on the basis of an increment amount of sheet interval time of the print sheet in continuous printing and a heater turning-on time, (b) derives the heater control temperature by correcting a predetermined reference value by the correction value within a range that the correction value does not exceed an upper limit value, (c) sets the upper limit value on the basis of the upper limit increment amount of the sheet interval time and the heater turning-on time, and (d) decreases a value of the heater turning-on time when the sheet interval time of the print sheet decreases. Here, the heater turning-on time is a value that indicates an accumulated time of power-on time of the fuser heater from starting the continuous printing.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a block diagram that indicates a part of an electronic configuration of the image forming apparatus in the embodiment according to the present disclosure;

FIG. 3 shows a diagram that explains a correction value of a heater control temperature;

FIG. 4 shows a diagram that explains an upper limit value of a correction value of a heater control temperature; and

FIG. 5 shows a flowchart that explains control of a fuser in the image forming apparatus shown in FIGS. 1 and 2.

### DETAILED DESCRIPTION

Hereinafter, embodiments according to an aspect of the present disclosure will be explained with reference to drawings.

### Embodiment 1

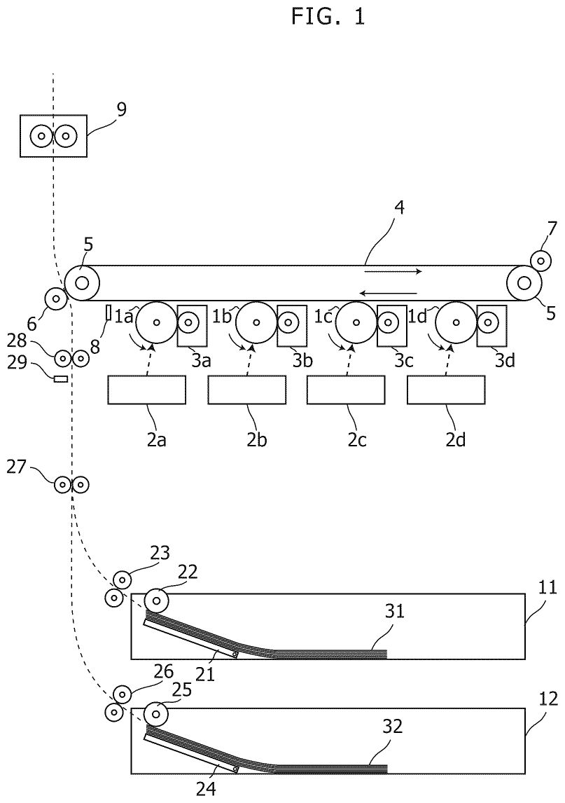

FIG. 1 shows a side view that indicates an internal mechanical configuration of an image forming apparatus in an embodiment according to the present disclosure. The image forming apparatus shown in FIG. 1 is an apparatus having an electrophotographic printing function, such as a printer, a facsimile machine, a copier or a multi function peripheral.

The image forming apparatus in this embodiment includes a tandem-type color development device. This color development device includes photoconductor drums 1a to 1d, exposure devices 2a to 2d, and development units 3a to 3d. The photoconductor drums 1a to 1d are photoconductors of four toner colors: Cyan, Magenta, Yellow and Black.

The exposure devices 2a to 2d are devices that form electrostatic latent images by scanning and irradiating the photo conductor drums 1a to 1d with laser light, respectively. The photo conductor drum 1a, 1b, 1c or 1d is scanned with the laser light in a direction (a primary scanning direction) perpendicular to a rotation direction (a secondary scanning direction) of the photoconductor drum. The exposure devices 2a to 2d include laser scanning units that include laser diodes as light sources of the laser light, and optical elements (such as lens, mirror and polygon mirror) that guide the laser light to the photoconductor drums 1a to 1d, respectively.

Further, the periphery of each one of the photo conductor drums 1a to 1d includes a charging unit such as scorotron, a cleaning device, a static electricity eliminator and the like. The cleaning device removes residual toner on each one of the photo conductor drums 1a to 1d after primary transfer. The static electricity eliminator eliminates static electricity of each one of the photoconductor drums 1a to 1d after primary transfer.

The development unit 3a, 3b, 3c or 3d includes a toner cartridge and a development device. The toner cartridge contains toner of one of four colors: Cyan, Magenta, Yellow, and Black. The toner is supplied from a toner hopper in the toner cartridge to the development device. The development device adheres the toner on the photoconductor drum 1a, 1b, 1c, or 1d. The development unit 3a, 3b, 3c, or 3d forms a toner image by adhering the toner to an electrostatic latent image on the photoconductor drum 1a, 1b, 1c, or 1d.

The photoconductor drum 1a, the exposure device 2a and the development unit 3a perform development of Magenta. The photoconductor drum 1b, the exposure device 2b and the development unit 3b perform development of Cyan. The photoconductor drum 1c, the exposure device 2c and the development unit 3c perform development of Yellow. The photoconductor drum 1d, the exposure device 2d and the development unit 3d perform development of Black.

An intermediate transfer belt 4 is a loop-shaped image carrier (here an intermediate transfer member), and contacts the photoconductor drums 1a to 1d. Toner images on the photoconductor drums 1a to 1d are primarily transferred onto the intermediate transfer belt 4. The intermediate transfer belt 4 is hitched around driving rollers 5, and rotates by driving force of the driving rollers 5 towards the direction from the contact position with the photoconductor drum 1d to the contact position with the photoconductor drum 1a.

A transfer roller 6 causes an incoming paper sheet in transportation mentioned below to contact the transfer belt 4, and secondarily transfers the toner image on the transfer belt 4 to a print sheet. The print sheet on which the toner image has been transferred is transported to a fuser 9, and consequently, the toner image is fixed on the print sheet.

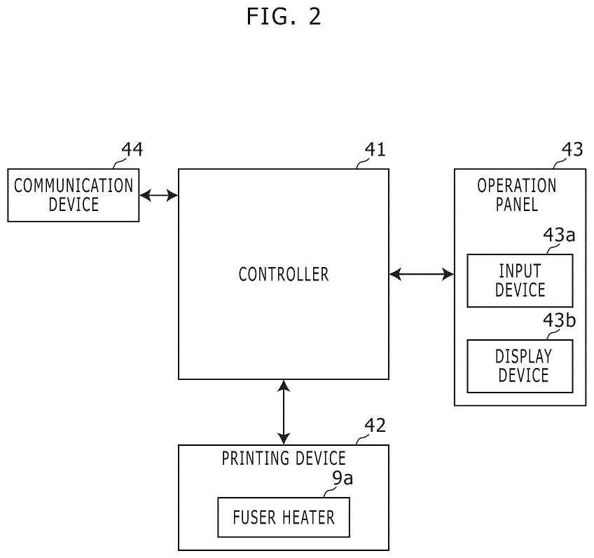

The fuser 9 includes a built-in fuser heater 9a (see FIG. 2), and fixes a toner image of a print sheet in a heating-and-pressurizing manner. Specifically, a toner image corresponding to a print image is transferred on a print sheet, the fuser 9 fixes the toner image to the print sheet in a heating-and-pressurizing manner. The fuser heater 9a is a heater including a resistance heating element, such as ceramic heater or planar heater. For example, the fuser heater 9a is arranged in an internal structural member that supports a fuser belt, a fuser film or the like, in a fuser roller or the like. Thus, the fuser heater 9a heats a specific part (a fuser belt, a fuser film or the like, in a fuser roller or the like) using resistance heating.

A roller 7 includes a cleaning brush, and removes residual toner on the intermediate transfer belt 4 by the cleaning brush contacting to the intermediate transfer belt 4 after transferring the toner image to a print sheet and/or after toner density calibration or toner gradation calibration.

A sensor 8 irradiates the intermediate transfer belt 4 with a light beam, and detects its reflection light from a surface of the intermediate transfer belt 4 or a toner pattern on the intermediate transfer belt 4. For example, in a calibration of toner gradation and/or toner density, the sensor 8 irradiates a predetermined area (an area onto which a toner patch for calibration is transferred) on the intermediate transfer belt 4 with a light beam, detects its reflection light, and outputs an electronic signal corresponding to the received light amount.

Further, the image forming apparatus of this embodiment includes plural paper sheet cassettes 11, 12. The sheet feeding cassettes 11, 12 store print sheets 31, 32, and push up the print sheets 31, 32 using lift plates 21 and 24 so as to cause the print sheets 31, 32 to contact with pickup rollers 22, 25, respectively. The print sheets 31, 32 put on the sheet feeding cassette 11, 12 are picked up to a sheet feeding roller 23, 26 by the pickup roller 22, 25 sheet by sheet from the upper side. The sheet feeding rollers 23, 26 are rollers that transport the print sheets 31, 32 sheet by sheet fed by the pickup rollers 22, 25 from the sheet feeding cassettes 11, 12 onto a transportation path.

A transportation roller 27 is a transportation roller on the transportation path common to the print sheets 31, 32 transported from the sheet feeding cassettes 11, 12.

A registration roller 28 temporarily stops an incoming print sheet, and at a second feeding timing, transports the print sheet to a transfer position between the intermediate transfer belt 4 and the transfer roller 6. The second feeding timing is specified by a controller 41 mentioned below so as to cause a toner image on the intermediate transfer belt 4 to be transferred to a specified position on the print sheet. A registration sensor 29 is a sensor that is arranged near the registration roller 28, and optically detects that a print sheet reaches the registration roller 28 (i.e. registration position).

FIG. 2 shows a block diagram that indicates a part of an electronic configuration of the image forming apparatus in the embodiment according to the present disclosure. As shown in FIG. 2, the image forming apparatus includes a controller 41, a printing device 42, an operation panel 43, and a communication device 44.

The controller 41 includes a computer, an ASIC (Application Specific Integrated Circuit) and/or the like and thereby embodies sorts of processing units with software and/or hardware, watches and controls an internal device such as the printing device 42, and performs sorts of data processing.

The controller 41 receives a print request from an unshown host device using the communication device 44 for example, and in accordance with the print request, performs an image process (color conversion, color correction, halftoning and/or the like) specified for each page by the print request and controls the printing device 42, and thereby performs a print job. Specifically, the controller 41 controls a driving source that drives the transportation roller and the like, a bias application circuit that applies a development bias and a primary-transfer bias, the exposure devices 2a to 2d, and fixation temperature of the fuser 9 (e.g. temperature of the fuser heater 9a), and thereby performs forming an electrostatic latent image, development of a toner image, transfer and fixation of the toner image, and feeding and outputting of a print sheet.

Further, the printing device 42 is an internal device that performs printing of a document image using a mechanical configuration shown in FIG. 1.

The operation panel 43 include an input device 43a such as touch panel and/or head key that receives a user operation, and a display device 43b such as a liquid crystal display that displays an operation screen to a user. The communication device 44 such as a wireless or wired network interface, a modem or a peripheral device interface performs data communication with an unshown host device or the like.

Furthermore, the controller 41 performs power control of the fuser heater 9a for a heater control temperature. Specifically, the controller 41 (a) derives a correction value tc of the heater control temperature on the basis of an increment amount DT (an increment amount from a reference value obtained from a linear velocity, a sheet size and the like) of sheet interval time of print sheets in continuous printing, and (b) derives the heater control temperature by correcting a predetermined reference value by the correction value tc within a range that the correction value tc does not exceed an upper limit value tcl. Here, the controller 41 (c) sets the upper limit value tcl on the basis of the increment amount DT of the sheet interval time and a heater turning-on time TF. It should be noted that in continuous printing, sheet interval time changes due to change of a print sheet size, change of sheet feeding cassette and/or the like.

Further, the controller 41 (d) decreases a value of the heater turning-on time TF when the sheet interval time of print sheets decreases. Here, the heater turning-on time TF is a value that indicates an accumulated time of power-on time of the fuser heater 9a from starting the continuous printing.

In Embodiment 1, the controller 41 resets a value of the heater turning-on time TF to zero when the sheet interval time of print sheets decreases.

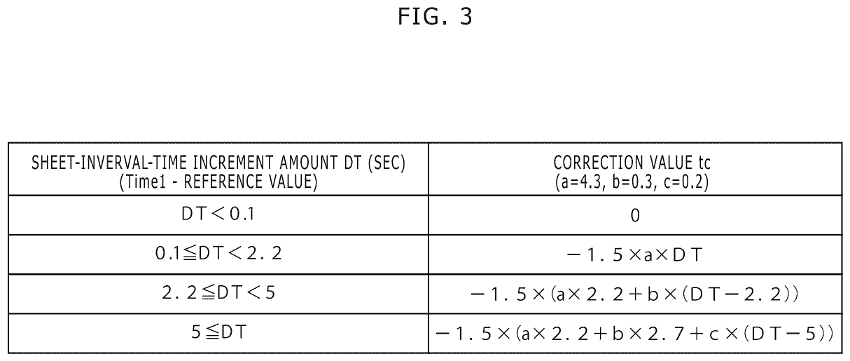

FIG. 3 shows a diagram that explains a correction value of a heater control temperature. As shown in FIG. 3, for example, the controller 41 derives the correction value tc on the basis of the increment amount DT of the sheet interval time in accordance with a calculation formula, a table or the like, and derives the heater control temperature by subtracting the correction value tc from a reference value. FIG. 3 shows values in a case that a linear velocity of the print sheets is 40 PPM and the print sheets have an A4 size.

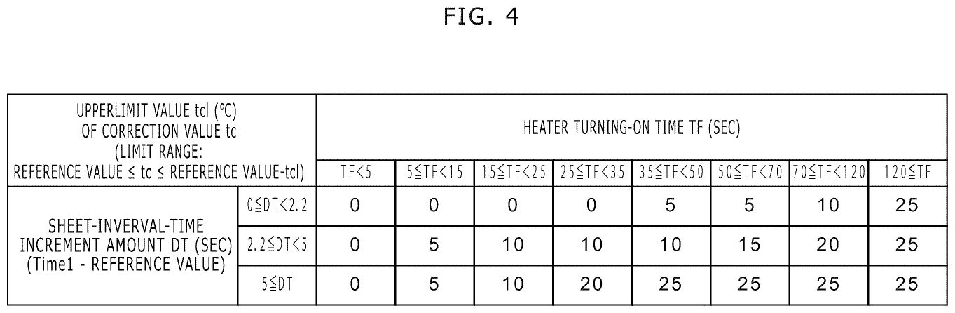

FIG. 4 shows a diagram that explains an upper limit value of a correction value of a heater control temperature. As shown in FIG. 4, for example, the controller 41 sets the upper limit value tcl on the basis of the increment amount DT of the sheet interval time and the heater turning-on time TF in accordance with a calculation formula, a table or the like. As shown in FIG. 4, for example, the upper limit value tcl is set to be higher when the increment amount DT of the sheet interval time becomes larger, and the upper limit value tcl is set to be higher when the value of the heater turning-on time TF becomes larger.

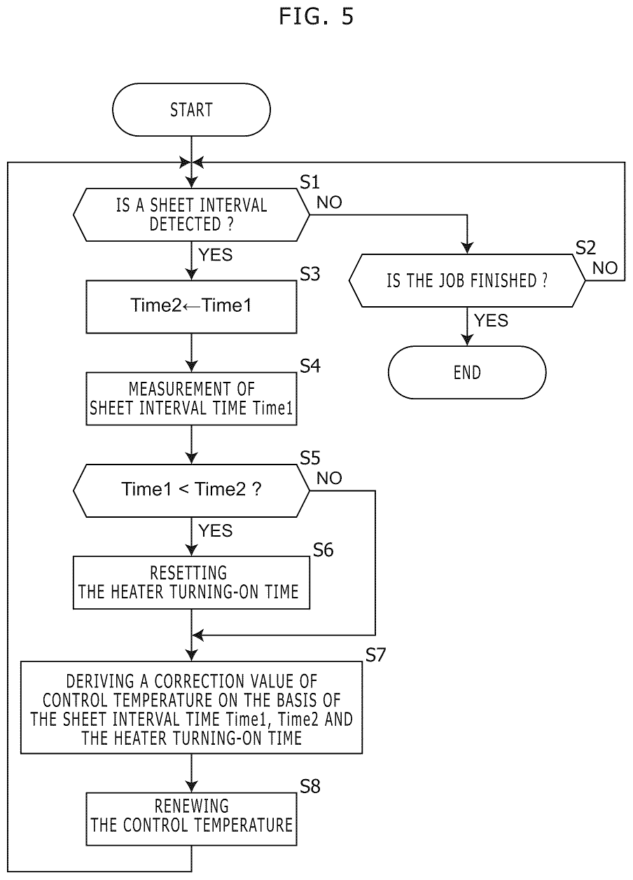

The following part explains a behavior of the aforementioned image forming apparatus 1. FIG. 5 shows a flowchart that explains control of a fuser in the image forming apparatus shown in FIGS. 1 and 2.

Upon starting a job of continuous printing, the controller 41 performs power control of the fuser heater 9a, and watches whether a sheet interval is detected (in Step S1) and whether the job is finished (in Step S2).

If the sheet interval is detected, then the controller 41 sets a current sheet interval time Time1 to sheet interval time Time2 that indicates previous sheet interval time (in Step S3), determines sheet interval time of the detected sheet interval and renews the sheet interval time Time1 with the determined sheet interval time.

Subsequently, the controller 41 determines whether the sheet interval time decreases or not (i.e. whether Time1<Time2 or not) (in Step S5).

If the sheet interval time decreases (i.e. in case that Time1<Time2), the controller 41 resets a value of the heater turning-on time (in Step S6); and otherwise if not, does not reset a value of the heater turning-on time.

Further, the controller 41 derives the correction value tc correspondingly to the increment amount DT of the sheet interval time Time1 (=Time1−Reference value) as shown in FIG. 3, for example, and derives the upper limit value tcl on the basis of the increment amount DT of the sheet interval time and the current heater turning-on time; and if the correction value tc exceeds the upper limit value tcl, then changes the correction value tc to the upper limit value tcl as shown in FIG. 4, for example (in Step S7).

Afterward, the controller 41 renews the control temperature of the fuser heater 9a at a predetermined time point (in Step S8). For example, this predetermined time point is (a) a time point that the fuser 9 releases nipping of a rear end of a first print sheet after the heater turning-on time exceeds a predetermined value, (b) a time point that a next print sheet after the heater turning-on time exceeds a predetermined value reaches a transportation position corresponding to a time point predetermined time (here, 100 msec) before the fuser 9 starts nipping of a current print sheet (this time point is detected by a sheet sensor arrange at the transportation position), (c) a time point that a job request is received, (d)) a time point that output of a previous print sheet after printing is finished, or the like.

Afterward, returning to Step S1, the controller 41 continues the aforementioned watching until the job is finished.

As mentioned, in Embodiment 1, the controller 41 derives a correction value tc of a heater control temperature on the basis of an increment amount DT of sheet interval time of print sheets in continuous printing, and derives the heater control temperature by correcting a predetermined reference value by the correction value tc within a range that the correction value tc does not exceed an upper limit value tcl. Here, the controller 41 sets the upper limit value tcl on the basis of the increment amount DT of the sheet interval time and a heater turning-on time TF. Further, when the sheet interval time of print sheets decreases, the controller 41 decreases a value of the heater turning-on time TF.

Consequently, the upper limit value is set for the correction value of the heater control temperature, and therefore, even if the sheet interval time decreases in continuous printing, the fixation temperature is properly maintained.

### Embodiment 2

In Embodiment 2, the controller 41 resets a value of the heater turning-on time TF to a value corresponding to a decrement amount of the sheet interval time when the sheet interval time of print sheets decreases.

For example, if the decrement amount of the sheet interval time (Time2−Time1) is equal to or larger than 2 seconds, then a value of the heater turning-on time TF is set to zero; if the decrement amount of the sheet interval time is equal to or larger than 1 second but less than 2 seconds, then a value of the heater turning-on time TF is set to a value of one third of a current value of the heater turning-on time TF; and if the decrement amount of the sheet interval time is equal to or larger than 0 second but less than 1 second, then a value of the heater turning-on time TF is set to a value of two thirds of a current value of the heater turning-on time TF.

Other parts of the configuration and behaviors of the image forming apparatus in Embodiment 2 are identical or similar to those in Embodiment 1, and therefore not explained here.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, while the image forming apparatus of the aforementioned embodiment is an indirect-transfer image forming apparatus, the feature of the present disclosure can also be applied to a direct-transfer image forming apparatus.

What is claimed is:

1. An image forming apparatus, comprising:
a fuser configured to fix a toner image on a print sheet using a fuser heater in a heating- and pressurizing manner; and
a controller configured to perform power control of the fuser heater for a heater control temperature;
wherein the controller (a) derives a correction value of the heater control temperature on the basis of an increment amount of sheet interval time of the print sheet in continuous printing and a heater turning-on time, (b) derives the heater control temperature by correcting a predetermined reference value by the correction value within a range that the correction value does not exceed an upper limit value, (c) sets the upper limit value on the basis of the otherwise, increment amount of the sheet interval time and the heater turning-on time, and (d) decreases a value of the heater turning-on time when the sheet interval time of the print sheet decreases; and
the heater turning-on time is a value that indicates an accumulated time of power-on time of the fuser heater from starting the continuous printing.

2. The image forming apparatus according to claim 1, wherein the upper limit value is set to be higher when the increment amount of the sheet interval time becomes larger; and
the upper limit value is set to be higher when the value of the heater turning-on time becomes larger.

3. The image forming apparatus according to claim 1, wherein the controller resets the value of the heater turning-on time to zero when the sheet interval time decreases.

4. The image forming apparatus according to claim 1, wherein the controller resets the value of the heater turning-on time to a value corresponding to a decrement amount of the sheet interval time when the sheet interval time decreases.
